(19) United States
(12) Patent Application Publication
(10) Pub. No.: US 2009/0204319 A1
(43) Pub. Date: Aug. 13, 2009

(54) REAL TIME PARKING SEARCH AND POINT-TO-POINT DIRECTION GENERATOR

(75) Inventors: Amit Umesh Shanbhag, San Francisco, CA (US); Glen Ames, Mountain View, CA (US); Philip Aaronson, Mountain View, CA (US)

Correspondence Address: FIALA & WEAVER, P.L.L.C.;C/O CPA GLOBAL, P.O. BOX 52050, MINNEAPOLIS, MN, 55402, US

(73) Assignee: YAHOO! INC., Sunnyvale, CA (US)

(21) Appl. No.: 12/029,243

(22) Filed: Feb. 11, 2008

(51) Int. Cl. G01C 21/34; G06Q 10/00; G06F 17/30; G06F 3/048

(52) U.S. Cl. 701/201; 705/5; 707/5; 715/764; 707/E17.017

(57) ABSTRACT

Methods, systems, and apparatuses for mapping parking locations and for selecting parking are described. A search for parking resources proximate to a destination geographic location is performed. Parking information is generated based on the results of the search. The parking information may be displayed on a map of the destination geographical location. A map of the destination geographical location may be displayed with the parking information. A user may be enabled to select a parking location indicated on the map. The user may reserve the selected parking location if the selected parking location is determined to be reservable. Travel directions (e.g., for walking) from the selected parking location to the destination geographic location may be generated, and may be indicated on the map.

### BACKGROUND OF THE INVENTION

1. Field of the Invention

The present invention relates to computer-aided mapping, and in particular, to the determining and displaying of parking information on maps.

2. Background Art

To efficiently drive from one geographic location to another, it generally is beneficial to have driving directions. A number of interactive Internet-based mapping portals are available to generate such driving directions, including Yahoo!® Maps, MapQuest, and Google™ Maps. To use a mapping portal to generate driving directions, a user typically enters a start location (e.g., in the form of an mailing address) and a finish location. The mapping portal processes the start location and finish location information, and generates a map with generated driving directions overlaid thereupon.

Frequently, an individual that plans on driving from a start location to a finish location will need a parking space at the finish location. The locating of parking in towns/cities having scarce parking resources and/or strict parking regulations is a non-trivial task. Unfamiliarity by the individual with the destination locality can further compound this problem. Thus, the locating of parking in many localities can be time consuming.

Furthermore, parking can be quite expensive due to any resulting fees that the individual may need to pay to park in a particular parking resource. Locating relatively inexpensive parking around airports, stadiums, malls, and other destinations presents a different kind of challenge. Many of these types of locations have multiple competing parking service providers that offer varying parking options at varying rates. For example, parking spaces relatively close to an airport are likely to cost more than parking spaces that are located farther away.

Thus, planning a point-to-point trip that accounts for a need to find parking can be quite a complex problem. What is desired are ways of efficiently and easily planning a point-to-point trip that accounts for the need for parking at the end destination.

### BRIEF SUMMARY OF THE INVENTION

Methods, systems, and apparatuses for mapping parking locations and for selecting parking are described. In a first aspect of the present invention, a search for parking resources proximate to a destination geographic location is performed. Parking information is generated based on the results of the search. The parking information is configured to be displayed on a map of the destination geographical location. A map of the destination geographical location may be displayed, with the parking information indicated on the map.

In a further aspect, a user may be enabled to select a parking location that is indicated on the map. Whether the selected parking location is reservable may optionally be determined. The user may reserve the selected parking location if the selected parking location is determined to be reservable.

In a still further aspect, walking and/or public transit directions from the selected parking location to the destination geographic location may optionally be generated. The generated travel directions may be indicated on the map.

In another aspect of the present invention, a parking information generator is provided. The parking information generator includes a parking search module and a parking information processing module. The parking search module is configured to perform a search for parking resources proximate to a destination geographic location, and to generate parking resource search results. For example, the parking search module may access one or more databases that contain parking resource information (e.g., information about parking lots, parking garages, street/metered parking, etc.). The parking search module may determine one or more parking locations located within a predetermined distance from the destination, for instance. The parking information processing module is configured to receive the parking resource search results from the parking search module. The parking information processing module is configured to generate parking information that is configured to be displayed on a map of the destination geographical location based on the received parking resource search results.

In still another aspect of the present invention, a system for generating trip information is provided. The system includes the parking information generator and a map generator. The parking information generator is configured to perform a search for parking resources proximate to a destination geographic location, and to generate parking information based on results of the search for parking resources. The map generator is configured to generate map data to enable display of a map of the destination geographical location with the generated parking information indicated on the map.

The system may further include a display device configured to display the map of the destination geographic location with the generated parking information indicated on the map. The map may be displayed in a graphical user interface (GUI), for example, such as a GUI provided by a web page of a website. The GUI may enable the user to select and reserve a parking location that is displayed on the map.

In a further aspect, the map generator may be configured to generate travel directions from the selected parking location to the destination geographic location. The map generator may generate map data that enables display of the map with the generated travel directions from the selected parking location to the destination geographic location on the map.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of an example map generating system.

FIG. 2 shows a block diagram of a map generating system, according to an example embodiment of the present invention.

FIG. 3 shows a flowchart for determining parking resources, according to an example embodiment of the present invention.

FIG. 4 shows a block diagram of a network-based implementation of a map generating system, according to an embodiment of the present invention.

FIG. 5 shows a flowchart for generating driving directions, according to an example embodiment of the present invention.

FIG. 6 shows a block diagram of a graphical user interface (GUI) for requesting and interacting with parking, according to an example embodiment of the present invention.

FIG. 7 shows a map displaying parking information, according to an example embodiment of the present invention.

FIG. 8 shows a flowchart for reserving a parking location, according to an example embodiment of the present invention.

FIG. 9 shows a block diagram of an example GUI that enables parking reservations to be made, according to an embodiment of the present invention.

FIG. 10 shows a map displaying an example parking reservation interface, according to an example embodiment of the present invention.

FIG. 11 shows a block diagram of a network-based implementation of a map generating system that enables parking reservations, according to an embodiment of the present invention.

FIG. 12 shows a flowchart for providing travel directions from a parking location, according to an example embodiment of the present invention.

FIG. 13 shows a map with travel directions from a parking location to the destination, according to an example embodiment of the present invention.

FIG. 14 shows a block diagram of an example computer system in which embodiments of the present invention may be implemented.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### Example Mapping Portal

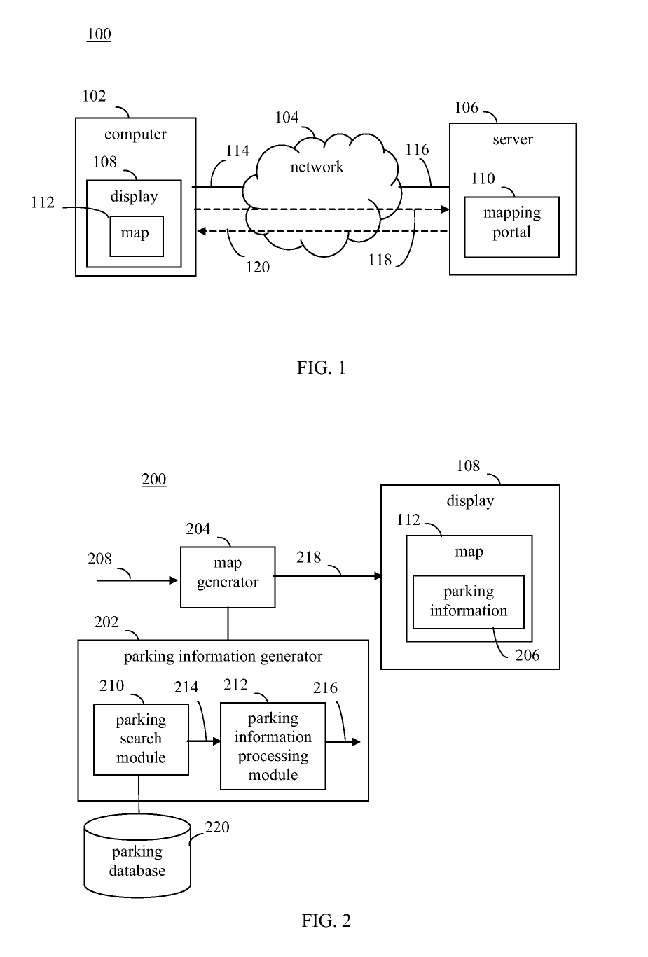

Embodiments of the present invention relate to mapping tools, such as Internet-based mapping portals. FIG. 1 shows an example network-based map generating system 100. Map generating system 100 includes a computer 102, a network 104, and a server 106. Computer 102 has a display 108. A mapping portal 110 resides on server 106. Mapping portal 110 is a map generating tool that may be used to generate a map of a region, and that may generate driving directions for display on the map. Mapping portal 110 may be one of a number of available interactive Internet-based mapping portals, such as Yahoo!® Maps, MapQuest, and Google™ Maps.

To generate driving directions using mapping portal 110, a user typically enters a start location (e.g., in the form of an address, a city, a zip code, etc.) and a destination location into an interface (e.g., a web browser) at computer 102. Computer 102 transmits the entered start and destination location information in a first communication signal 118 through network 104 to server 106. Mapping portal 110 in server 106 receives and processes the start location and destination location information, and generates map data, which may include mapping information regarding the start and destination locations, and information for driving from the start location to the destination location. Server 102 transmits the map data in a second communication signal 120 through network 104 to computer 102. Display 108 of computer 102 displays a map 112 based on the map data contained in second communication signal 120. Map 112 shows the start and destination locations, and also shows driving directions between the start and destination locations.

Frequently, an individual that plans on driving from a start location to a destination location will need a parking space at the destination location. The individual may be unfamiliar with the destination location, and thus may not know beforehand where to find convenient parking and/or parking at an acceptable cost. Conventional mapping portals, such as mapping portal 110, do not provide assistance in finding suitable parking for users who are planning trips.

Embodiments of the present invention overcome the deficiencies of conventional mapping portals by enabling users to find parking at destination locations. Example embodiments of the present invention are described in detail in the following sections.

### Example Embodiments for Parking Searching and Mapping

Example embodiments are described for planning travel and for locating parking at destination locations. For example, embodiments enable a determination of available parking at a destination location. Embodiments enable the display the determined parking on maps. The example embodiments described herein are provided for illustrative purposes, and are not limiting. Further structural and operational embodiments, including modifications/alterations, will become apparent to persons skilled in the relevant art(s) from the teachings herein.

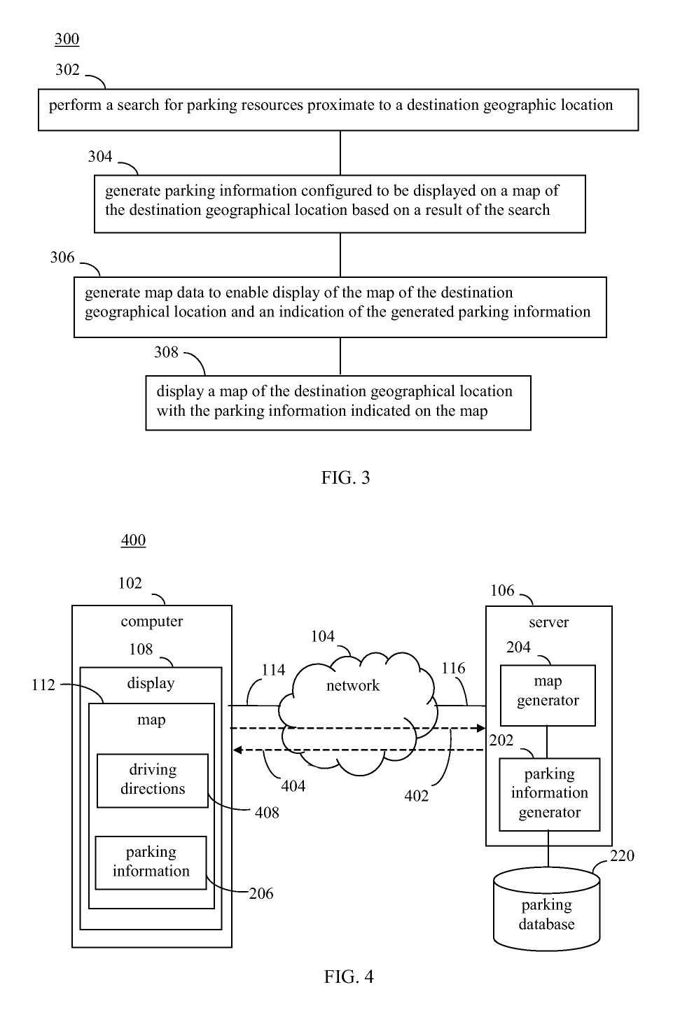

FIG. 2 shows a map generating system 200, according to an example embodiment of the present invention. As shown in FIG. 2, map generating system 200 includes a parking information generator 202, a map generator 204, a parking database 220, and display 108. As shown in FIG. 2, parking information generator 202 is coupled to map generator 204. Map generating system 200 is configured to generate parking related information for a geographic location, and may also generate travel directions if requested. Map generating system 200 may be configured to generate travel and/or parking related information in various ways. For instance, in an embodiment, map generating system 200 may operate according to a process shown in FIG. 3. FIG. 3 shows a flowchart 300 for determining parking resources, according to an example embodiment of the present invention. Map generating system 200 is described as follows with respect to flowchart 300. Further structural and operational embodiments will be apparent to persons skilled in the relevant art(s) based on the discussion regarding flowchart 300.

Flowchart 300 begins with step 302. In step 302, a search for parking resources proximate to a destination geographic location is performed. Step 302 may be performed by parking information generator 202 shown in FIG. 2. Referring to FIG. 2, map generator 204 may receive a travel request signal 208. Travel request signal 208 includes a destination geographic location, and may include further travel parameters, such as a first geographic location, which is a geographic location on a desired travel path prior to the destination geographic location. Map generator 204 receives travel request signal 208. In an embodiment, map generator 204 provides the destination geographic location received in travel request signal 208 to parking information generator 202. In another embodiment, travel request signal 208 is also received by parking information generator 202.

Parking information generator 202 is configured to generate parking information regarding parking resources proximate to the received destination geographic location. In an embodiment, parking information generator 202 may include a parking search module 210 and a parking information processing module 212. Parking search module 210 performs a search for parking resources proximate to the destination geographic location contained in travel parameters signal 208. For example, as shown in FIG. 2, parking search module 210 may access a parking database 220. Parking database 220 stores information on parking locations, parking lot capacity, cost of parking, and/or further parking-related data. Parking database 220 may be a database stored in a single location, or may include multiple databases stored in various locations. Parking database 220 may be local to parking information generator 202 (e.g., in attached storage), or may be accessed over one or more networks (e.g., network 104 shown in FIG. 4). Parking database 220 may store location information for parking resources in any format, including in the form of world coordinates or any other format used for determining distances between locations, as would be known to persons skilled in the relevant art(s). Example providers of parking information for parking database 220 may include private parking service providers, city/county traffic/parking departments, etc.

Parking search module 210 may extract the location of parking resources (e.g., parking lots, individual parking spaces, street parking, metered parking, parking garages, etc.) from parking database 220 that are proximate to the destination geographic location. For instance, parking search module 210 may determine the location of one or more parking resources from parking database 220 that are within a particular distance (e.g., a radial distance, a walking/driving distance, etc.) of the destination geographic location. The distance may be a predetermined distance, or may be a user selectable distance. As shown in FIG. 2, parking search module 210 generates parking resource search results 214, which includes one or more parking locations that are proximate to the destination geographic location.

In step 304, parking information configured to be displayed on a map of the destination geographical location is generated based on results of the search. In an embodiment, parking information processing module 212 of parking information generator 202 generates the parking information. Parking information processing module 212 receives parking resource search results 214 from parking search module 210, and generates a parking information signal 216. Parking information signal 216 includes parking information formatted in a manner than can be processed by map generator 204. For example, parking information processing module 212 may format the parking search results data so that it may be easily incorporated into the map data generated by map generator 204, such as by converting the parking search results into a graphical format and/or map data format. For example, module 212 may generate code, such as JavaScript™ code, or ActionScript code compatible with Flash technology, that can be used to overlay the parking information on a map generated by map generator 204.

Furthermore, parking information processing module 212 may perform filtering of the parking search results based on user preferences received in travel request signal 208. Examples of such filtering are described elsewhere herein, and include filtering based on parking cost, availability, distance from parking to destination, availability of public transportation to get from parking to destination, etc. Parking information signal 216 is transmitted from parking information generator 202 to map generator 204.

In step 306, map data is generated to enable display of a map of the destination geographical location and an indication of the generated parking information. In an embodiment, map generator 204 is configured to generate map data to enable display of map 112, which includes a map of the destination geographical location. Furthermore, map generator 204 is configured to incorporate the parking information received from parking information generator 202 into the map data so that one or more parking locations proximate to the destination geographic location are displayed on map 112. In embodiments, map generator 204 may be a local map generating tool (e.g., personal computer-based) or may be a remotely accessible map generating tool, such as an Internet-based mapping portal. Example Internet-based mapping portals for map generator 204 include Yahoo!® Maps, MapQuest, and Google™ Maps. As shown in FIG. 2, map generator 204 generates map data signal 218, which includes data for generating a map of the destination geographic location with the generated parking information. Map data signal 218 may optionally also include driving directions for display in map 112. Map data signal 218 may have any format, including being JavaScript™ code or ActionScript code, that can be used to generate map 112.

In step 308, a map of the destination geographical location is displayed with the parking information indicated on the map. As shown in FIG. 2, display 108 receives map data signal 218. Display 108 generates a display of map 112 from the map data in map data signal 218. As shown in FIG. 2, map 112 includes parking information 206. Parking information 206 displayed in map 112 may include parking lots, parking spaces (e.g., street parking), parking garages, and/or any other type of parking resource. Furthermore, parking information 206 may include further information/data regarding the displayed parking, include a cost of parking, hours of operation of parking, number of available parking spots, information to enable reservation of parking, etc. Such information/data may have been extracted by parking information generator 202 from parking database 220 and/or from network accessible interfaces for parking resources, and provided in map data signal 218.

Map generating system 200 shown in FIG. 2 may be implemented in a single computer system or may be implemented across multiple computer systems. For example, in an embodiment, map generator 204 may be implemented in a first computer system and parking information generator 202 may be implemented in a second computer system. The first and second computer systems may be coupled together in any manner, including in a network, such as a local area network (LAN), a wide area network (WAN), or combination or networks (e.g., the Internet). Parking information generator 202 and map generator 204 may be implemented in hardware, software, firmware, or any combination thereof. For example, parking information generator 202 and map generator 204 may be implemented as code that executes in one or more processors in one or more computer systems. Alternatively, parking information generator 202 and/or map generator 204 may be implemented as hardware logic in one or more integrated circuit chips. Display 108 may be any type of display device, including a cathode ray tube (CRT) display, a flat panel display such as a plasma or LCD (liquid crystal display) display, or other type of display device. Some example embodiments for map generating system 200 are described below.

FIG. 4 shows a network-based implementation of a map generating system 400, according to an embodiment of the present invention. As shown in FIG. 4, map generating system 400 includes computer 102, network 104, and server 106. Computer 102 includes display 108. Map generator 204 resides in server 106. Computer 102 may be any type of computer mentioned herein or otherwise known, including a personal computer (e.g., a desktop computer), a mobile computer (e.g., a Palm® device, a personal digital assistant (PDA), a laptop computer, a notebook computer, etc.), a mobile email device (e.g., a RIM Blackberry® device), a mobile phone (e.g., a cell phone), a personal navigation device (e.g., a handheld global position system (GPS) device), or other computing device. Server 106 may be an application server computer or other type of server/computer system. Network 104 may be a LAN, a WAN, or combination of networks, including the Internet.

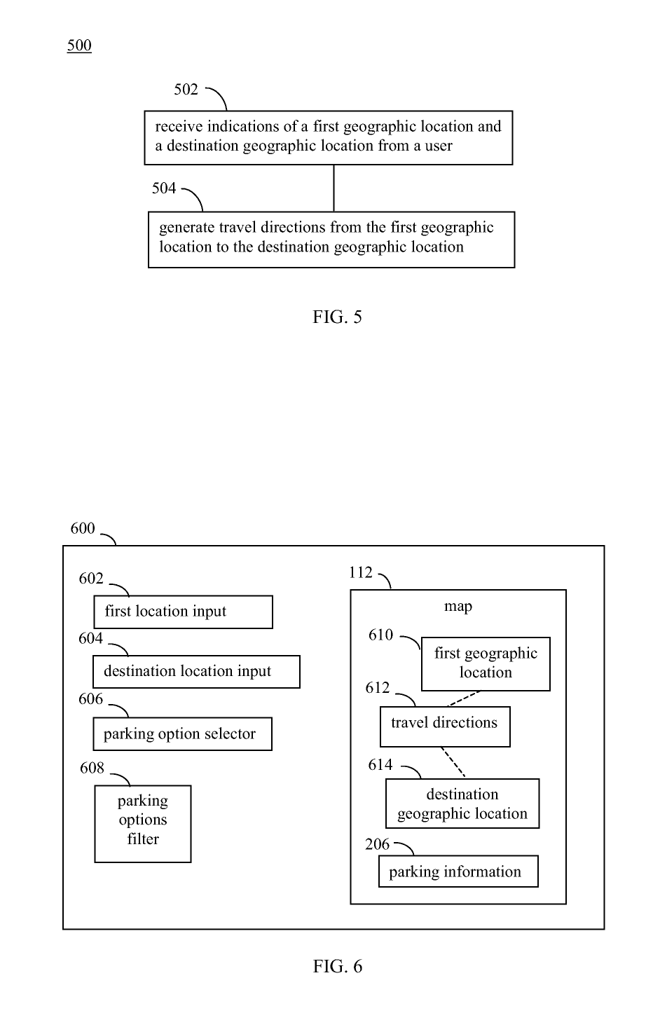

In the embodiment of FIG. 4, a user interacts with computer 102 to generate driving directions. For example, the steps of flowchart 500 shown in FIG. 5 may be performed. In step 502, indications of a first geographic location and a destination geographic location are received from a user. A user typically enters a start location (e.g., in the form of an address, city, zip code, etc.) and a destination location into an interface at computer 102. Any type of interface for receiving the location information may be provided at computer 102. For example, FIG. 6 shows a graphical user interface (GUI) 600 that may be provided by display 108 for the user. As shown in FIG. 6, GUI 600 includes a first location input 602, a destination location input 604, a parking option selector 606, a parking option filter 608, and map 112. GUI 600 may be a web browser window (e.g., displaying a web page) or other window type. The user may enter a start location for a trip into first location input 602, and may enter a destination location for the trip into destination location input 604. For example, first and destination location inputs 602 and 604 may be text entry blocks or other graphical/textual GUI structures that enable a user to enter location information.

The first and destination location information entered into inputs 602 and 604 is transmitted from computer 102 in a first communication signal 402 through network 104 to server 106. Map generator 204 in server 106 may perform step 504 of flowchart 500 shown in FIG. 5 (e.g., while performing step 306 of flowchart 300 described above). In step 504, travel directions from the first geographic location to the destination geographic location are generated. Map generator 204 processes the received start location and destination location information, and generates map data that includes driving directions from the first location to the destination location. Server 106 generates a second communication signal 404 that includes the generated map data. Second communication signal 404 is transmitted from server 106 through network 104 to computer 102.

Display 108 of computer 102 displays map 112 based on the map data contained in second communication signal 404. As shown in FIG. 4, display 108 shows map 112, which includes driving directions 408. In the example of display 108 shown in FIG. 6, GUI 600 shows map 112. Map 112 in GUI 600 shows the start location as first geographic location 610, and shows the destination location as destination geographic location 614. Map 112 further shows the generated driving directions as travel directions 612 between first and destination geographic locations 610 and 614.

According to embodiments of the present invention, a user interacting with GUI 600 may desire to find parking information with respect to destination geographic location 614. In an embodiment, GUI 600 may include a parking option selector 606. When present, parking option selector 606 in GUI 600 enables a user to request that a search for parking be performed. For example, parking option selector 606 may be a graphical button, check box, or other graphical/textual structure that enables a user to request a parking search. Alternatively, parking option selector 606 is not present, and a parking search may be performed for all requests for driving directions placed by users, or a parking search may be performed based on a context of the driving direction request. In an example of a parking search performed based on search context, logic of parking information generator 202 may evaluate characteristics of the destination, and may determine that parking is needed, such as when a search is performed for directions to a restaurant or a theater. In another example, the logic may determine that parking is not needed, such as when a search is requested for directions to a person's home.

When parking option selector 606 is present and is selected by a user, first communication signal 402 transmitted from computer 102 (as shown in FIG. 4) includes a request for parking information. Server 106 receives first communication signal 402 with the request for parking information, and may perform steps 302-306 of flowchart 600 to generate map data with parking information, as described above. Server 106 generates second communication signal 404 to include the generated map data and parking information. Second communication signal 404 is transmitted from server 106 through network 104 to computer 102. As shown in FIG. 4, display 108 of computer 102 displays map 112, which includes driving directions 408 and parking information 206. In the example of FIG. 6, map 112 displayed in GUI 600 includes parking information 206.

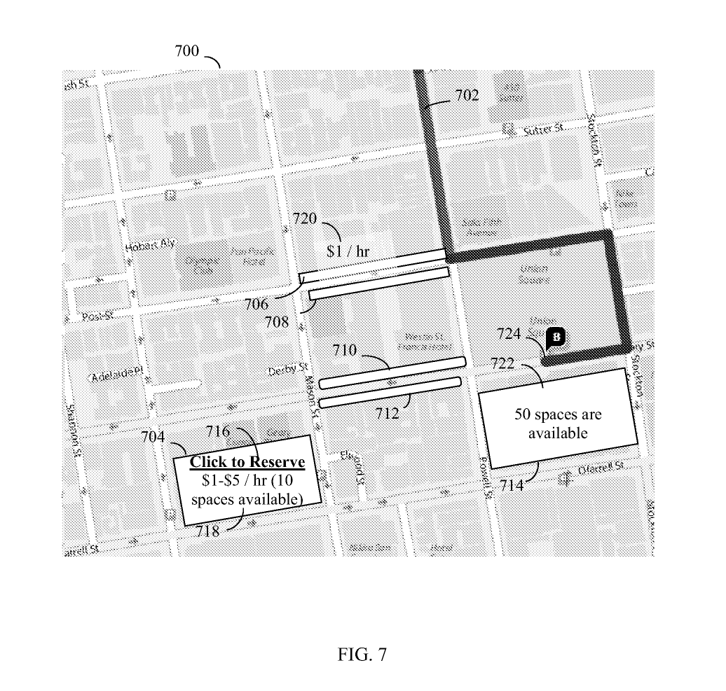

FIG. 7 shows a map 700 as an example of map 112, according to an embodiment of the present invention. Map 700 is a map of a region, showing various geographical and navigational features, including roads and buildings. Map 700 includes an indication of a destination geographic location 724. Furthermore, map 700 shows a plot of driving directions 702 from a first geographic location (not shown in map 700 due to the degree of zoom) to destination geographic location 724. In the example of FIG. 7, driving directions 702 are shown as a line that follows selected roads/streets and turns several corners in map 700. Still further, map 700 shows various examples of parking information 206, including the location of parking spaces and data regarding the indicated parking spaces.

For instance, map 700 indicates the location of a parking garage 704, first-fourth street parking regions 706, 708, 710, and 712, and a parking lot 714. Map 700 shows the parking locations within the displayed region, such that they can be viewed in relation to destination geographic location 724. Thus, a user viewing map 700 at display 108 is able to ascertain relative distances between the displayed parking spaces and destination geographic location 724, which may aid the user in planning/selecting which of the parking resources to potentially use for parking.

As shown in FIG. 7, map 700 provides further information regarding the indicated parking spaces, including cost and availability information. For instance, with regard to parking garage 704, cost and availability information 718 is displayed. In the current example, cost and availability information 718 indicates that 10 parking spaces are available in parking lot 704, and that the parking spaces in parking garage 704 cost $1-$5 per hour. With regard to first street parking region 706, cost information 720 is displayed. Cost information 720 indicates that parking spaces in first street parking region 706 each cost $1 per hour. With regard to parking lot 714, availability information 722 is displayed. Availability information 722 indicates that 50 parking spaces are available for parking in parking lot 714. Thus, a user that views map 700 at display 108 is able to determine further attributes about the indicated parking spaces, including availability information and cost information. The values shown in FIG. 7 for parking availability and cost are provided for illustrative purposes. Further attributes regarding parking that may be included in parking information 206 include an indication of whether parking spaces are reservable, a size of the parking spaces (e.g., compact car, motorcycle, etc.), availability of handicap parking, an indication of an average time needed to walk from the parking location to the destination location, and/or any other information relevant to parking.

Note that the further information regarding the indicated parking spaces may be provided textually, as described above, and/or in a graphical manner. For instance, parking locations may be color coded based on availability of parking. For example, a parking location may be indicated as red to indicate no parking available, may be indicated as yellow to indicate limited parking available, and may be indicated as green if parking is abundant. In another example, a graphical indication may be used to indicate relative cost of parking. For example, “$$$” may be used to represent highly expensive parking, “$$” may be used to represent moderately expensive parking, and “$” may be used to represent relatively inexpensive parking.

A user of computer 102 may print map 700 (e.g., using a printer) if desired, to bring map 700 on the trip defined by driving directions 702. The user may refer to the print out of map 700 in order to navigate the trip pursuant to driving directions 702, and to locate one or more of the identified parking locations (parking garage 704, first-fourth street parking regions 706, 708, 710, and 712, and parking lot 714). In an embodiment, prior to the trip, the user may reserve one of the identified parking spaces. Example embodiments for reserving a parking space are described in the following section.

### Example Embodiments for Parking Reservations

In embodiments, a user may be enabled to reserve a parking location that is found in a parking search. For instance, flowchart 300 shown in FIG. 3 may include further steps that enable reservation of parking. Example embodiments are described below with respect to FIGS. 7-11 that enable parking to be reserved. The example embodiments are provided for illustrative purposes, and are not limiting. Further structural and operational embodiments, including modifications/alterations, will become apparent to persons skilled in the relevant art(s) from the teachings herein.

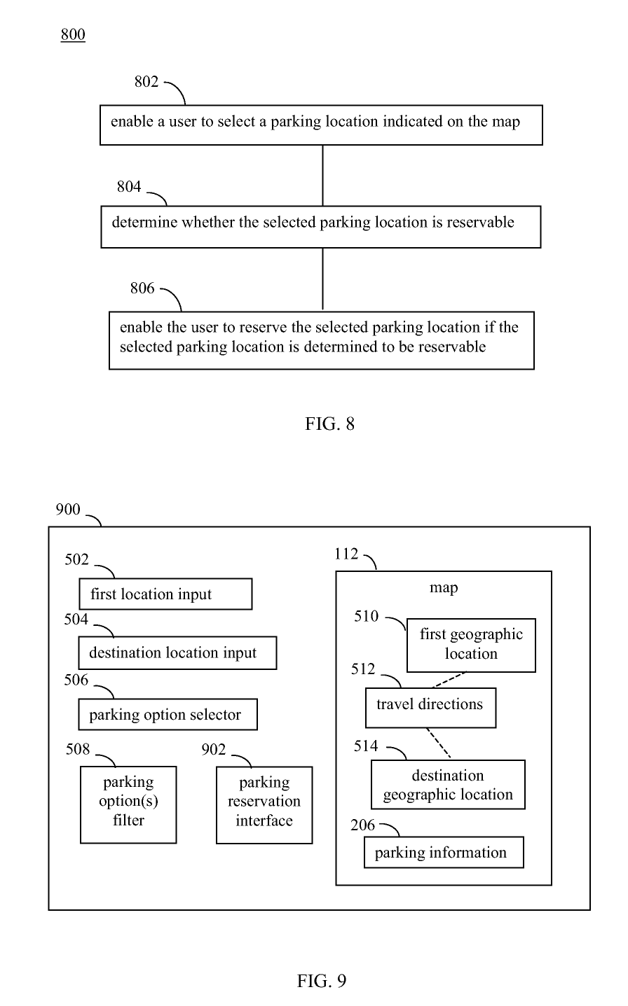

FIG. 8 shows a flowchart 800 for reserving a parking location, according to an example embodiment of the present invention. Flowchart 800 may be performed as a continuation of flowchart 300 shown in FIG. 3. Further structural and operational embodiments will be apparent to persons skilled in the relevant art(s) based on the description provided below regarding flowchart 800. Flowchart 800 is described as follows.

Flowchart 800 begins with step 802. In step 802, a user is enabled to select a parking location indicated on the map. A user may be enabled to select a parking location indicated on map 112 in a variety of ways, including by pointing and clicking on a displayed parking location using a mouse pointer. For example, a user interacting with map 700 shown in FIG. 7 may click on the rectangle representing parking garage 704 if the user is interesting in parking in parking garage 704.

In step 804, whether the selected parking location is reservable is determined. In an embodiment, parking information 206 may include information regarding whether particular parking resources may be reserved. Such information may be a textual message, a graphical symbol/indication (e.g., a reservation icon), or other indication that particular parking is reservable. For example, as shown in FIG. 7, parking garage 704 includes a reservation link 716, which states “click to reserve.” The presence of reservation link 716 may indicate that a parking spaces in parking garage 704 is reservable.

In step 806, the user is enabled to reserve the selected parking location if the selected parking location is determined to be reservable. For example, FIG. 9 shows a GUI 900 that enables parking reservations, according to an embodiment of the present invention. GUI 900 is similar to GUI 600 shown in FIG. 6, with the addition of a parking reservation interface 902. Parking reservation interface 902 enables a user to reserve a parking space that is indicated as reservable by parking information 206 in map 112. For example, parking reservation interface 902 may be a form that a user of GUI 900 can fill out to reserve a parking space indicated in map 112. In an embodiment, a user may type information (e.g., a name of the company owning the parking location, contact information for the company, etc.), which may be displayed in map 112 as parking information 206, into parking reservation interface 902 in map 112, to reserve a parking space. In another embodiment, GUI 900 may be configured such that information regarding the parking location selected in step 802 in map 112 (e.g., one of parking lot 704, first-fourth street parking regions 706, 708, 710, and 712, or parking garage 714) is automatically populated into parking reservation interface 902. By filling out and submitting the information input into parking reservation interface 902, the user may be able to reserve the parking space online.

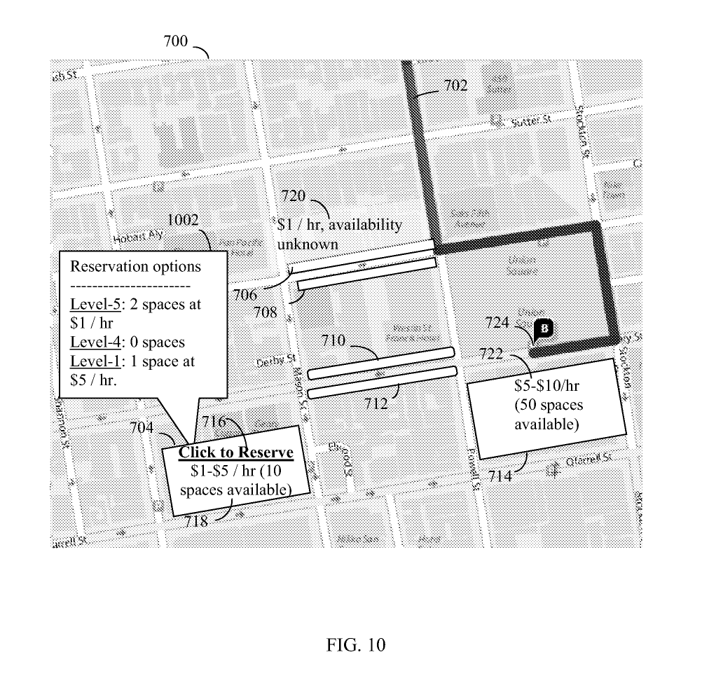

Parking reservation interface 902 may be displayed in GUI 900 external (as shown in FIG. 9) or internal to map 112. For example, FIG. 10 shows an example parking reservation interface 1002 displayed internal to map 700, according to an example embodiment of the present invention. Interface 1002 may be caused to be displayed in map 700 in any manner. For example, parking reservation interface 1002 may be displayed (e.g., in a “pop-up” manner) in response to the user moving a pointer over parking garage 704 in map 700 or in response to the user selecting parking garage 704 for parking. Interface 1002 displays parking information and options for parking garage 704. In the example of FIG. 10, interface 1002 shows parking availability for parking garage 704, indicating that 2 spaces are located available on Level 5, zero (0) spaces are available on Level 4, and 1 space is available on Level 1. Furthermore, interface 1002 indicates that the spaces available on Level 5 cost $1 per hour and that the space available on Level 1 costs $5 per hour. Based on this information, a user may select a link provided in interface 1002 for either of Levels 5 and 1 to reserve a corresponding parking space of parking garage 704.

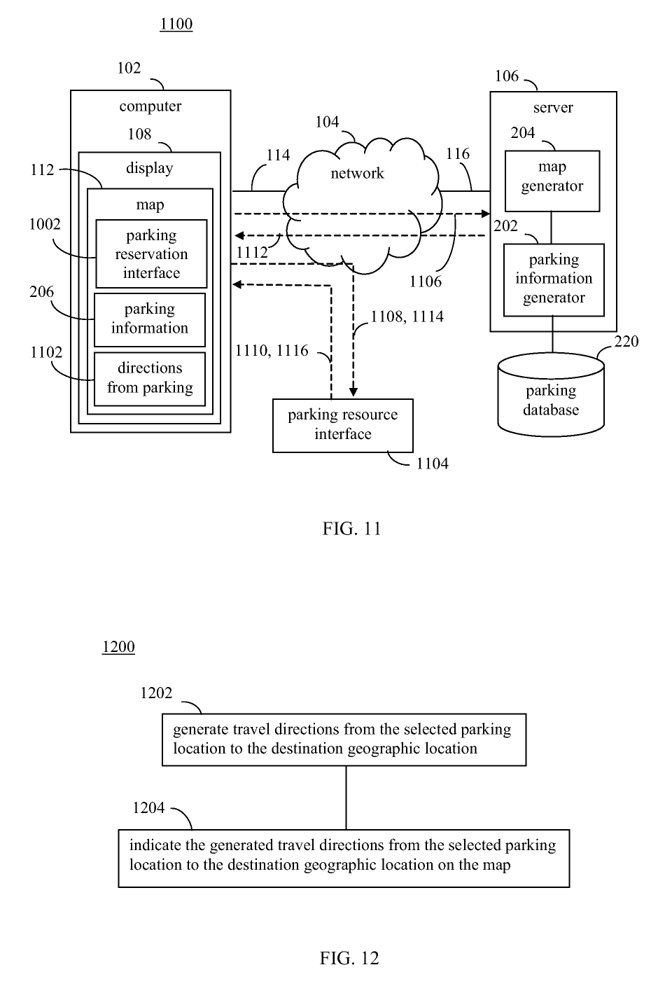

Thus, in an embodiment, a user may reserve a parking space by interacting with a parking reservation interface, such as interface 902 or 1002. FIG. 11 shows a network-based implementation of a map generating system 1100 showing an example parking reservation being made, according to an embodiment of the present invention. As shown in FIG. 11, system 1100 is similar to system 400 shown in FIG. 4, with the addition of a parking resource interface 1104. Parking resource interface 1104 may be an interface for communicating with an entity that provides parking spaces, such as an owner/operator of parking garage 704, street parking regions 706-712, or parking lot 714 shown in FIG. 10. For example, parking resource interface 1104 may be a network accessible interface, such as a website (e.g., a user accessible website, a web service, etc.), an FTP server, or other network accessible interface provided by a parking providing entity.

In the example of FIG. 11, a user of computer 102 may interact with a parking reservation interface, such parking reservation interface 1002 in map 112. The user may click on a link in interface 1002 to access parking resource interface 1104 to reserve parking. For example, the user of computer 102 may click on the link for Level 5 of parking garage 704 shown in FIG. 10, to attempt to reserve a parking space on Level 5. A first communication signal 1108 may be transmitted from computer 102 (e.g., over network 104) to parking resource interface 1104 with the parking request. Interface 1104 may process the parking request, and provide an indication in a second communication signal 1110 transmitted from interface 1104 to computer 102 that a parking space on Level 5 cannot be reserved (e.g., is no longer available), or that the parking space on Level 5 may be reserved. Second communication signal 1110 may also include a request for credit card or other payment mechanism from the user, and a date/time for the reservation, if a reservation is possible. The user may provide payment, date/time information, and/or other information to interface 1104 in a third communication signal 1114 transmitted by computer 102 to reserve the parking space. Interface 1104 may process the payment and date/time information, and transmit a confirmation of the reservation, or a denial of the reservation, to the user at computer 102 in a fourth communication signal 1116.

As shown in FIG. 11, further communications regarding the reservation may occur between computer 102 and server 106 (e.g., as indicated by communication signal 1106 from computer 102 to server 106, and communication signal 1112 from server 106 to computer 102) and/or between server 106 and interface 1104. For example, further communications may occur to provide an indication of the reservation in the map data generated by map generator 204 so that the reservation is displayed in GUI 900 at computer 102. For example, GUI 900 may display an indication of the parking reservation such as by stating “a parking space on Level 5 is reserved,” by highlighting parking garage 704 in map 112, and/or by otherwise indicating in GUI 900 that parking is reserved in parking garage 704.

As described above, a user of computer 102 may print map 700 (e.g., using a printer) if desired, to bring map 700 on the trip defined by driving directions 702. The user may refer to the print out of map 700 in order to navigate the trip pursuant to driving directions 702, and to locate a reserved parking space indicated in map 700. In an embodiment, prior to the trip, the user may further desire to generate travel directions from the reserved parking space to the destination location. Example embodiments for generating travel directions from reserved parking are described in the following section.

Example Embodiments for Mapping Travel Directions from Parking

After selecting a parking space, a user may desire travel directions (e.g., for walking, public transportation, etc.) to and from the parking space to the destination geographic location. In embodiments, travel directions from a parking space to the destination geographic location are generated and are displayed on a map. For instance, flowchart 300 shown in FIG. 3 may include further steps that enable generation and display of travel directions from parking. Example embodiments are described below with respect to FIGS. 11-13 that enable such directions to be generated and displayed. The example embodiments are provided for illustrative purposes, and are not limiting. Further structural and operational embodiments, including modifications/alterations, will become apparent to persons skilled in the relevant art(s) from the teachings herein.

FIG. 12 shows a flowchart 1200 for updating travel directions, according to an example embodiment of the present invention. Flowchart 1200 may be performed in map generating system 1100 shown in FIG. 11. Further structural and operational embodiments will be apparent to persons skilled in the relevant art(s) based on the discussion regarding flowchart 1200. Flowchart 1200 is described as follows.

Flowchart 1200 begins with step 1202. In step 1202, travel directions from the selected parking location to the destination geographic location are generated. After the user selects a parking location in step 804, an indication of the selected parking location is transmitted to server 106 (e.g., in communication signal 1106). Map generator 204 receives the indication of the selected parking location, and generates map data that includes travel directions from the selected parking location to the destination location. For instance, a user may select a parking location in parking lot 714 shown in FIG. 7. Map generator 204 generates map data that includes travel directions from parking lot 714 to destination geographic location 724. Server 106 generates a communication signal (e.g., communication signal 1112 shown in FIG. 11) that includes the generated map data, which is transmitted from server 106 through network 104 to computer 102.

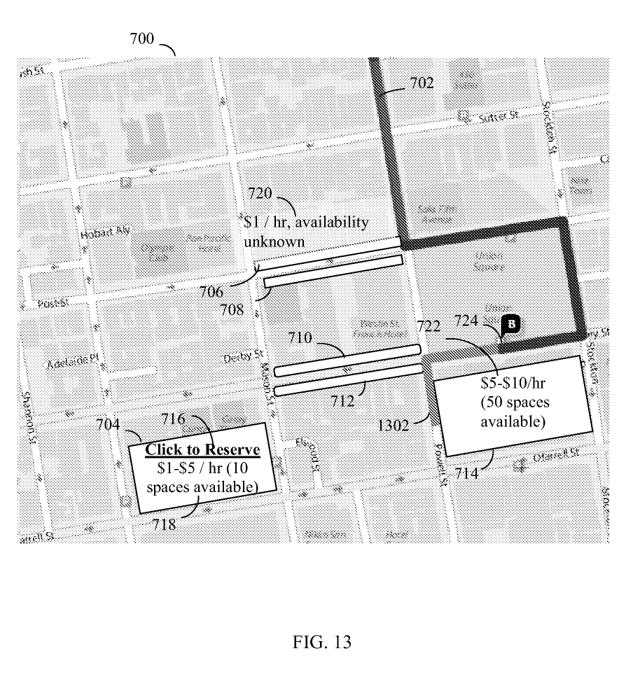

In step 1204, the generated travel directions from the selected parking location to the destination geographic location are indicated on the map. Display 108 of computer 102 displays map 112 based on the map data contained in the received communication signal, including the travel directions from the parking location to the destination. For example, FIG. 13 shows map 700 with travel directions 1302 from parking, according to an example embodiment of the present invention. As shown in FIG. 13, map 700 shows travel directions 1302, which are graphical travel directions (e.g., a line) from parking lot 714 to destination geographic location 724. Travel directions 1302 may be followed by the user walking from parking lot 714 to destination geographic location 724, and from destination geographic location 724 to parking lot 714. In the event that the length of travel direction 1302 is greater than a predetermined distance and/or that public transportation (e.g., bus, subway, etc.) may be taken from parking lot 714 to destination geographic location 724 (and from destination location geographic location 724 to parking lot 714), such public transportation options may be additionally indicated in map 700.

As described above, a user of computer 102 may print map 700 (e.g., using a printer) if desired, to bring map 700 on the trip defined by driving directions 702. The user may refer to the print out of map 700 in order to navigate the trip pursuant to driving directions 702, to view a selected parking location, and view travel directions 1302 from the parking location to the destination location.

### Example Computer Implementation

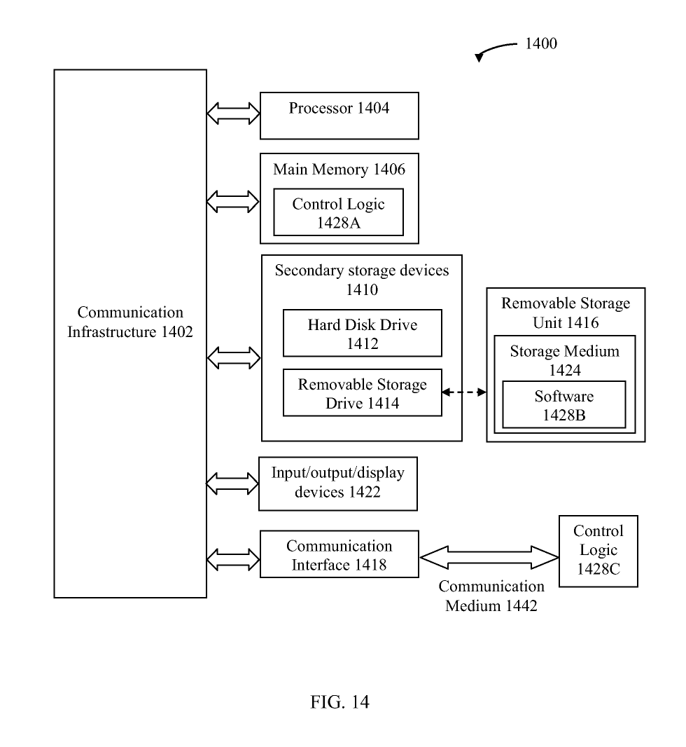

The embodiments described herein, including systems, methods/processes, and/or apparatuses, may be implemented using well known servers/computers, such as computer 1400 shown in FIG. 14. For example, computer 102 and server 106 can be implemented using one or more computers 1400. Furthermore, map generating system 200 of FIG. 2, flowchart 300 of FIG. 3, flowchart 500 of FIG. 5, flowchart 800 of FIG. 8, and flowchart 1200 of FIG. 12 may be implemented in one or more such computers 1400.

Computer 1400 can be any commercially available and well known computer capable of performing the functions described herein, such as computers available from International Business Machines, Apple, Sun, HP, Dell, Cray, etc. Computer 1400 may be any type of computer, including a desktop computer, a server, etc.

Computer 1400 includes one or more processors (also called central processing units, or CPUs), such as a processor 1404. Processor 1404 is connected to a communication infrastructure 1402, such as a communication bus. In some embodiments, processor 1404 can simultaneously operate multiple computing threads.

Computer 1400 also includes a primary or main memory 1406, such as random access memory (RAM). Main memory 1406 has stored therein control logic 1428A (computer software), and data.

Computer 1400 also includes one or more secondary storage devices 1410. Secondary storage devices 1410 include, for example, a hard disk drive 1412 and/or a removable storage device or drive 1414, as well as other types of storage devices, such as memory cards and memory sticks. For instance, computer 1400 may include an industry standard interface, such a universal serial bus (USB) interface for interfacing with devices such as a memory stick. Removable storage drive 1414 represents a floppy disk drive, a magnetic tape drive, a compact disk drive, an optical storage device, tape backup, etc.

Removable storage drive 1414 interacts with a removable storage unit 1416. Removable storage unit 1416 includes a computer useable or readable storage medium 1424 having stored therein computer software 1428B (control logic) and/or data. Removable storage unit 1416 represents a floppy disk, magnetic tape, compact disk, DVD, optical storage disk, or any other computer data storage device. Removable storage drive 1414 reads from and/or writes to removable storage unit 1416 in a well known manner.

Computer 1400 also includes input/output/display devices 1422, such as monitors, keyboards, pointing devices, etc., as may be described elsewhere herein or otherwise known.

Computer 1400 further includes a communication or network interface 1418. Communication interface 1418 enables the computer 1400 to communicate with remote devices. For example, communication interface 1418 allows computer 1400 to communicate over communication networks or mediums 1442 (representing a form of a computer useable or readable medium), such as LANs, WANs, the Internet, etc. Network interface 1418 may interface with remote sites or networks via wired or wireless connections.

Control logic 1428C may be transmitted to and from computer 1400 via the communication medium 1442. More particularly, computer 1400 may receive and transmit carrier waves (electromagnetic signals) modulated with control logic 1428C via communication medium 1442.

Any apparatus or manufacture comprising a computer useable or readable medium having control logic (software) stored therein is referred to herein as a computer program product or program storage device. This includes, but is not limited to, computer 1400, main memory 1406, secondary storage devices 1410, removable storage unit 1416 and carrier waves modulated with control logic 1428C. Such computer program products, having control logic stored therein that, when executed by one or more data processing devices, cause such data processing devices to operate as described herein, represent embodiments of the invention.

Embodiments of the present invention can work with software, hardware, and/or operating system implementations other than those described herein. Any software, hardware, and operating system implementations suitable for performing the functions described herein can be used.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of planning a trip, comprising:
performing a search for parking resources proximate to a destination geographic location; and
generating parking information configured to be displayed on a map of the destination geographical location based on results of the search.

2. The method of claim 1, further comprising:
displaying a map of the destination geographical location with the parking information indicated on the map.

3. The method of claim 2, wherein the parking information includes at least one parking location, the method further comprising:
enabling a user to select a parking location indicated on the map.

4. The method of claim 3, further comprising:
determining whether the selected parking location is reservable; and
enabling the user to reserve the selected parking location if the selected parking location is determined to be reservable.

5. The method of claim 3, further comprising:
generating travel directions from the selected parking location to the destination geographic location; and
indicating the generated travel directions from the selected parking location to the destination geographic location on the map.

6. The method of claim 2, wherein said performing a search for parking resources proximate to the destination geographic location comprises:
performing the search for parking resources in an area within a predetermined distance from the destination geographical location.

7. The method of claim 2, further comprising:
filtering the parking information indicated on the map according to one or more of a price of parking, an availability of parking, an availability of public transportation, or a distance of parking from the destination geographical location.

8. The method of claim 2, further comprising:
receiving indications of a first geographic location and the destination geographic location from a user;
generating travel directions from the first geographic location to the destination geographic location; and
displaying the generated travel directions from the first geographic location to the destination geographic location on the map.

9. A parking information generator, comprising:
a parking search module configured to perform a search for parking resources proximate to a destination geographic location, and to generate parking resource search results; and
a parking information processing module configured to receive the parking resource search results from the parking search module, and to generate parking information configured to be displayed on a map of the destination geographical location based on the received parking resource search results.

10. A system for generating trip information, comprising:
a parking information generator configured to perform a search for parking resources proximate to a destination geographic location, and to generate parking information based on results of the search for parking resources; and
a map generator configured to generate map data to enable display of a map of the destination geographical location with the generated parking information indicated on the map.

11. The system of claim 10, wherein the parking information includes at least one parking location, wherein the map generator is configured to receive a selection of a parking location indicated on the map;
wherein the map generator is configured to generate travel directions from the selected parking location to the destination geographic location, and to generate second map data that enables display of the map with the generated travel directions from the selected parking location to the destination geographic location on the map.

12. The system of claim 10, wherein the parking information generator is configured to perform the search for parking resources in an area within a predetermined distance from the destination geographical location.

13. The system of claim 10, wherein the parking information generator is configured to filter the parking information indicated on the map according to one or more of a price of parking, an availability of parking, an availability of public transportation, or a distance of parking from the destination geographical location.

14. The system of claim 10, wherein the map generator is configured to receive indications of a first geographic location and the destination geographic location from a user, to generate travel directions from the first geographic location to the destination geographic location, and to generate the map data to enable display of the map with the generated travel directions from the first geographic location to the destination geographic location indicated on the map.

15. A computer program product comprising a computer usable medium having computer readable program code means embodied in said medium for planning a trip, comprising:
a first computer readable program code means for enabling a processor to perform a search for parking resources proximate to a destination geographic location;
a second computer readable program code means for enabling a processor to generate parking information configured to be displayed on a map of the destination geographical location based on results of the search; and
a third computer readable program code means for enabling a processor to display a map of the destination geographical location with the parking information indicated on the map.

16. The computer program product of claim 15, wherein the parking information includes at least one parking location, the method further comprising:
a fourth computer readable program code means for enabling a processor to enable a user to select a parking location indicated on the map.

17. The computer program product of claim 16, further comprising:
a fifth computer readable program code means for enabling a processor to determine whether the selected parking location is reservable; and
a sixth computer readable program code means for enabling a processor to enable the user to reserve the selected parking location if the selected parking location is determined to be reservable.

18. The computer program product of claim 16, further comprising:
a fifth computer readable program code means for enabling a processor to generate travel directions from the selected parking location to the destination geographic location; and
a sixth computer readable program code means for enabling a processor to indicate the generated travel directions from the selected parking location to the destination geographic location on the map.

19. The computer program product of claim 15, wherein said first computer readable program code means comprises:
a fourth computer readable program code means for enabling a processor to perform the search for parking resources in an area within a predetermined distance from the destination geographical location.

20. The computer program product of claim 15, further comprising:
a fourth computer readable program code means for enabling a processor to filter the parking information indicated on the map according to one or more of a price of parking, an availability of parking, an availability of public transportation, or a distance of parking from the destination geographical location.

21. The computer program product of claim 15, further comprising:
a fourth computer readable program code means for enabling a processor to receive indications of a first geographic location and the destination geographic location from a user;
a fifth computer readable program code means for enabling a processor to generate travel directions from the first geographic location to the destination geographic location; and
a sixth computer readable program code means for enabling a processor to display the generated travel directions from the first geographic location to the destination geographic location on the map.
